(19) United States
(12) Patent Application Publication
(10) Pub. No.: US 2021/0334197 A1
(43) Pub. Date: Oct. 28, 2021

(54) BROWSER-BASED TESTS FOR HYBRID APPLICATIONS USING A LAUNCHER PLUG-IN

(71) Applicant: salesforce.com, inc., San Francisco, CA (US)

(72) Inventor: Wesley Peter, Sammamish, WA (US)

(73) Assignee: salesforce.com, inc., San Francisco, CA (US)

(21) Appl. No.: 16/860,195

(22) Filed: Apr. 28, 2020

(51) Int. Cl. G06F 11/36; G06F 9/455; G06F 9/445; H04L 29/08; G06F 16/957

(52) U.S. Cl. CPC G06F 11/3692; G06F 9/455; G06F 16/957; H04L 67/34; G06F 9/44526

(57) ABSTRACT

The present disclosure is directed to systems and methods for testing a hybrid application. For example a method may include: executing a plug-in on a computing device; in response to the executing the plug-in, generating an emulator for testing a hybrid application, the emulator simulating an operating system of a client device such that, during testing, the hybrid application replicates operations of a browser operating on the client device; installing the hybrid application in the emulator; notifying a server that the hybrid application is ready for testing; executing instructions received from the server for testing the hybrid application; and providing results from testing the hybrid application to the server.

### BACKGROUND

In current testing environments, browsers and hybrid applications are expected to operate in a same manner, and as such, are tested to confirm such operation. Browsers allow developers to display web content as part of layout of a user interface and hybrid applications may be a mobile web application, which can run natively on an operating system of a client device. Given the different nature of browsers and hybrid applications, they are tested in two different testing environments with two different sets of code. As a result, when changes are made with respect to one set of code, the changes are propagated to the other set of code as well. This results in the duplication of work, which is inefficient and costly.

### BRIEF DESCRIPTION OF THE DRAWINGS/FIGURES

The accompanying drawings are incorporated herein and form a part of the specification.

FIG. 1 is a block diagram of a system, according to some example embodiments.

FIG. 2 is a flowchart illustrating a process for testing a hybrid application, according to some example embodiments.

FIG. 3 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

It is to be appreciated that the Detailed Description section, and not the Abstract sections, is intended to be used to interpret the claims. The Summary and Abstract sections may set forth one or more but not all example embodiments as contemplated by the inventor(s), and thus, are not intended to limit the appended claims in any way.

The present disclosure is directed to a testing environment for a hybrid application, i.e., a web application running in a webview of a native application. A hybrid application may be a mobile web application which can run natively on an operating system of a client device, e.g., a mobile device. Hybrid applications may also be wrapped in a native shell, i.e., a shell of an application developed for use on a particular platform or device, which can be deployed to various mobile devices.

In this testing environment, a plug-in can execute an emulator on computing device, install the hybrid application under test within the emulator, test the hybrid application, and provide test results to a server. In some embodiments, the plug-in may be a program operating on a computing device that, when executed, generates the emulator. The emulator may enable an application developer to run an operating system on a hardware platform for which it was not designed (e.g., run the operating system of the client device on the computing device) and run an application (e.g., the hybrid) on a device (e.g., the computing device) other than the one it was developed for (e.g., the client device). Thus, in some embodiments, the emulator may simulate the operating system of a client device such that, during testing, the hybrid application replicates operations of a browser operating on the client device. Once the results are provided to the server, the emulator can be removed from the computing device. Testing the hybrid application can include directing the hybrid application to a webpage, such that the hybrid application replicates operations of the browser. That is, the hybrid application is treated as a browser, which allows for a single set of code for testing browsers and hybrid applications, whereas prior testing required a different set of code for each.

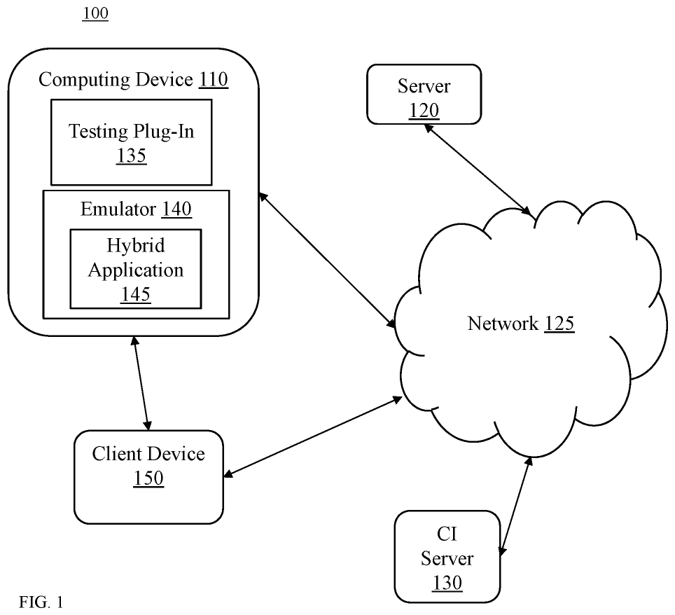

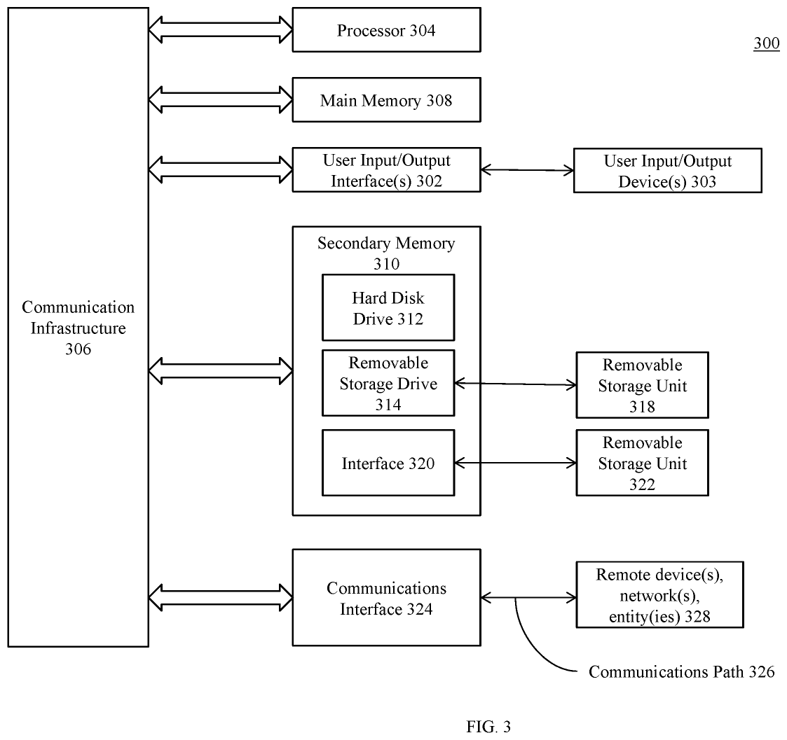

FIG. 1 is a diagram of an example environment 100 in which example systems and/or methods may be implemented. As shown in FIG. 1, environment 100 may include a computing device 110, a server 120, a network 125, a continuous integration (CI) server 130, and a client device 150. Devices of the environment 100 may interconnect via wired connections, wireless connections, or a combination of wired and wireless connections. Devices of environment 100 may include a computer system 300 shown in FIG. 3, discussed in greater detail below. The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of the environment 100 may perform one or more functions described as being performed by another set of devices of the environment 100.

In some embodiments, the computing device 110 may be, for example, a mobile phone (e.g., a smart phone, a radiotelephone, etc.), a laptop computer, a tablet computer, a handheld computer, a gaming device, a wearable communication device (e.g., a smart wristwatch, a pair of smart eyeglasses, etc.), or a similar type of device. Similarly, the client device 150 may be a mobile phone, a laptop computer, a tablet computer, a handheld computer, a gaming device, a wearable communication device (e.g., a smart wristwatch, a pair of smart eyeglasses, etc.), or a similar type of device that is configured to operate an application, such as a hybrid application described herein. The computing device 110 may be used to execute a testing plug-in 135. In some embodiments, the computing device 110 may be used to access the CI server 130, which may be configured to execute the processes described herein.

The server 120 may include a server device (e.g., a host server, a web server, an application server, etc.), a data center device, or a similar device, capable of communicating with the computing device 110 via the network 125. The network 125 may include one or more wired and/or wireless networks. For example, the network 125 may include a cellular network (e.g., a long-term evolution (LTE) network, a code division multiple access (CDMA) network, a 3G network, a 4G network, a 5G network, another type of next generation network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, and/or the like, and/or a combination of these or other types of networks.

In some embodiments, the computing device 110 can execute the testing plug-in 135 in response to receiving commands from a user. For example, the testing plug-in 135 may be executed in response to receiving instructions via a command line prompt. The command line prompt may include, for example, a node package manager (NPM), although it should be understood by those of ordinary skill in the art that any command line prompt may be used in accordance with aspects of the present disclosure. In some embodiments, the instructions may include instructions to execute the testing-plug in 135, identify which hybrid application 145 to be installed for testing, and a file location on the computing device 110 for retrieving the hybrid application 145. That is, based on the instructions, the computing device 110 may automatically execute the testing plug-in 135 and install the hybrid application 145.

In some embodiments, in response to executing the testing plug-in 135, the computing device 110 may generate an emulator 140 for testing the hybrid application 145. In some embodiments, the emulator 140 may simulate an operating system of the client device such that, during testing, the hybrid application 145 replicates operations of a browser operating on the client device. In some embodiments, generating the emulator may include determining whether a software development kit (SDK) for the operating system of the client device is installed on the computing device 110. For example, different operating systems for the client device may be downloaded as SDKs on the computing device 110, such that the computing device 110 may generate the emulator 140 simulating the operating system. In some embodiments, the computing device 110 may generate the emulator 140 in response to determining that the SDK is installed on the computing device 110. In contrast, the computing device 110 may generate an error message in response to determining that SDK is not installed on the computing device 110.

In some embodiments, to generate the emulator 140, the computing device 110 may also determine which system images were provided in the SDK. Each system image may be, for example, a copy of one version of the operating system, as should be understood by those of ordinary skill in the art. In some embodiments, the computing device 110 receive a selection of one of the system images, and the emulator 140 may be generated based on the selected system image. In some embodiments, the emulator 140 may be generated based on a default system image.

In some embodiments, the computing device 110 may also verify that the emulator 140 is operating on the computing device 110. For example, the computing device 110 may run a system check after a period of time, e.g., three (3) seconds, to determine whether the emulator 140 is operating on the computing device 110. The computing device 110 may iteratively execute the system check a predetermined number of iterations to verify whether the emulator 140 is operating on the computing device 110. In the event that the emulator 140 is not operating after the predetermined number of iterations, the computing device 110 may generate an error message.

In some embodiments, the computing device 110 may install the hybrid application 145 in the emulator 140 in response to the determining that the emulator 140 is active. For example, once the emulator 140 is operating on the computing device 110, the computing device 110 may automatically retrieve the execution file for installing the hybrid application 145 based on the file location received in the instructions. After locating the execution file, the computing device 110 may automatically install and launch the hybrid application 145. Once the hybrid application 145 in installed and launched in the emulator 140, the computing device 110 may send a notification to the server 120 that the hybrid application 145 is ready for testing, i.e., the hybrid application 145 has been installed and launched.

In response to receiving the notification from the computing device 110, the server 120 may transmit instructions for testing the hybrid application 145 back to the computing device 110. For example, the server 120 may transmit instructions that include a web address, e.g., a uniform resource locator (URL), for testing the hybrid application 145. In some embodiments, the server 120 may transmit the webpage address as a plain-text string using a framework that enables real-time bidirectional event-based communication between the computing device 110 and the server 120.

In response to receiving the instructions, the computing device 110 may execute the instructions received from the server for testing the hybrid application 145. For example, the instructions may direct the hybrid application 145 to access the webpage based on the web address. In some embodiments, in response to accessing the webpage, the hybrid application may retrieve tests to execute from the server 120. The webpage may be used to test whether the hybrid application 145 generates the images on the webpage are properly displayed. The webpage can also be used to test whether features, such as JavaScript and Flash, are functioning properly on the hybrid application 145. Additionally, the webpage can be used to perform code validation of the hybrid application 145, performance of the hybrid application 145 (e.g., how quickly does the hybrid application 145 render the webpage and/or does the webpage cause the hybrid application 145 to crash), are user interface (UI) features functioning in the hybrid application 145, or the like. In this way, the testing causes the hybrid application 145 to replicate operations of a browser operating on the client device. By doing so, the hybrid application 145 can be tested using the same set of test code as browsers.

In some embodiments, the computing device 110 may transmit the test results back to the server 120, which may in turn store the test results in a memory. Additionally, a developer using the computing device 110 may use the test results to modify the hybrid application 145, if necessary. In some embodiments, the developer may access the test results from the server 120 using a different computing device (not shown) to modify the hybrid application 145, if necessary.

In some embodiments, after receiving the test results, the server 120 may notify the computing device 110 to terminate the emulator 140. To do so, the computing device 110 may close and uninstall the hybrid application 145 operating in the emulator 140, and close the emulator 140. In some embodiments, the computing device 110 may automatically terminate the emulator 140 without further instruction from the server 120.

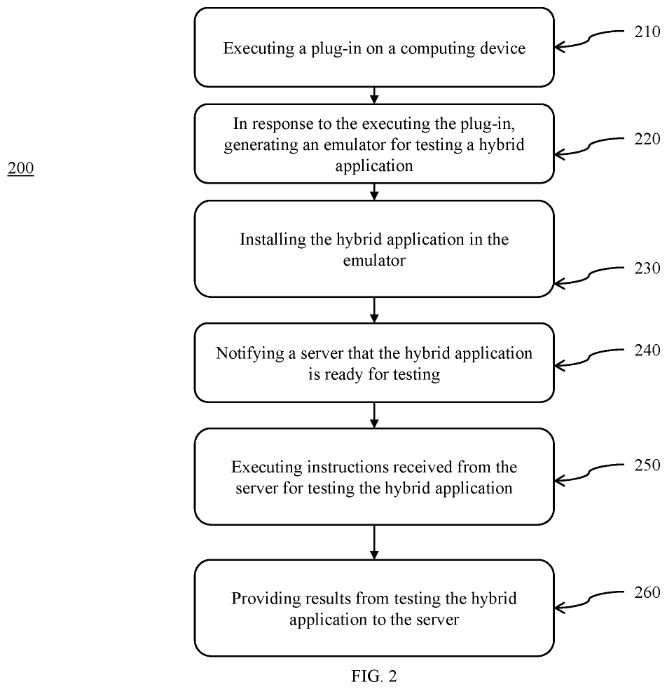

FIG. 2 is a flowchart illustrating a process for testing a hybrid application, according to some example embodiments. For example, at 210, a computing device, e.g., computing device 110 or CI server 130, may execute a plug-in, e.g., testing plug-in 135. For example, the testing plug-in 135 may be executed in response to receiving instructions via a command line prompt, e.g., an NPM. In some embodiments, the instructions may include instructions to execute the testing-plug in 135, identify an hybrid application, e.g., hybrid application 145, to be installed for testing, and a file location on the computing device 110 for retrieving the hybrid application 145.

At 220, in response to the executing the plug-in 135, the computing device 110 (or CI server 130) may generate an emulator, e.g., emulator 140, for testing the hybrid application 145. The emulator 140 may simulate an operating system of a client device, e.g., client device 150. By doing so, the hybrid application 145 may replicate operations of a browser operating on the client device 150 during testing. In some embodiments, generating the emulator may include determining whether an SDK for the operating system of the client device is installed on the computing device 110. In some embodiments, the computing device 110 may generate the emulator 140 in response to determining that the SDK is installed on the computing device. In contrast, the computing device 110 may generate an error message in response to determining that SDK is not installed on the computing device 110. Additionally, in some embodiments, generating the emulator 140 may be based on which system images were provided in the SDK. In some embodiments, the computing device 110 receive a selection of one of the system images, and the emulator 140 may be generated based on the selected system image. In some embodiments, the emulator 140 may be generated based on a default system image.

At 230, the computing device 110 (or CI server 130) may install the hybrid application in the emulator 140. To do so, the computing device 110 may verify that the emulator 140 is operating on the computing device 110. For example, in some embodiments, the computing device 110 may iteratively run a system check after a period of time to determine whether the emulator 140 is operating on the computing device 110. In the event that the emulator 140 is not operating after a predetermined number of iterations, the computing device 110 may generate an error message. In contrast, in response to the determining that the emulator 140 is active, the computing device 110 may install the hybrid application 145 in the emulator 140. For example, the computing device 110 may automatically retrieve the execution file for installing the hybrid application 145 based on the file location received in the instructions and automatically install and launch the hybrid application 145.

At 240, the computing device 110 (or CI server 130) may notify a server, e.g., server 120, that the hybrid application is ready for testing. For example, once the hybrid application 145 in installed and launched in the emulator 140, the computing device 110 may send a notification to the server 120 that the hybrid application 145 is ready for testing.

At 250, the computing device 110 (or CI server 130) may execute instructions received from the server 120 for testing the hybrid application 145. For example, the computing device 110 may receive instructions from the server 120, and in response, the computing device 110 may direct the hybrid application 145 to access a webpage based on a web address provided in the instructions, and the hybrid application may be tested, as described herein.

And, at 260, the computing device 110 (or CI server 130) may provide results from testing the hybrid application to the server 120.

Various embodiments may be implemented, for example, using one or more well-known computer systems, such as computer system 300 shown in FIG. 3. One or more computer systems 300 may be used, for example, to implement any of the embodiments discussed herein, as well as combinations and sub-combinations thereof.

Computer system 300 may include one or more processors (also called central processing units, or CPUs), such as a processor 304. Processor 304 may be connected to a communication infrastructure or bus 306.

Computer system 300 may also include user input/output device(s) 303, such as monitors, keyboards, pointing devices, etc., which may communicate with communication infrastructure 306 through user input/output interface(s) 302.

One or more of processors 304 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 300 may also include a main or primary memory 308, such as random access memory (RAM). Main memory 308 may include one or more levels of cache. Main memory 308 may have stored therein control logic (i.e., computer software) and/or data.

Computer system 300 may also include one or more secondary storage devices or memory 310. Secondary memory 310 may include, for example, a hard disk drive 312 and/or a removable storage device or drive 314. Removable storage drive 314 may be a floppy disk drive, a magnetic tape drive, a compact disk drive, an optical storage device, tape backup device, and/or any other storage device/drive.

Removable storage drive 314 may interact with a removable storage unit 318. Removable storage unit 318 may include a computer usable or readable storage device having stored thereon computer software (control logic) and/or data. Removable storage unit 318 may be a floppy disk, magnetic tape, compact disk, DVD, optical storage disk, and/any other computer data storage device. Removable storage drive 314 may read from and/or write to removable storage unit 318.

Secondary memory 310 may include other means, devices, components, instrumentalities or other approaches for allowing computer programs and/or other instructions and/or data to be accessed by computer system 300. Such means, devices, components, instrumentalities or other approaches may include, for example, a removable storage unit 322 and an interface 320. Examples of the removable storage unit 322 and the interface 320 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 300 may further include a communication or network interface 324. Communication interface 324 may enable computer system 300 to communicate and interact with any combination of external devices, external networks, external entities, etc. (individually and collectively referenced by reference number 328). For example, communication interface 324 may allow computer system 300 to communicate with external or remote devices 328 over communications path 326, which may be wired and/or wireless (or a combination thereof), and which may include any combination of LANs, WANs, the Internet, etc. Control logic and/or data may be transmitted to and from computer system 300 via communication path 326.

Computer system 300 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 300 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 300 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 300, main memory 308, secondary memory 310, and removable storage units 318 and 322, as well as tangible articles of manufacture embodying any combination of the foregoing. Such control logic, when executed by one or more data processing devices (such as computer system 300), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 3. In particular, embodiments can operate with software, hardware, and/or operating system embodiments other than those described herein.

While this disclosure describes example embodiments for example fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

The foregoing description of the example embodiments will so fully reveal the general nature of the invention that others can, by applying knowledge within the skill of the art, readily modify and/or adapt for various applications such specific embodiments, without undue experimentation, without departing from the general concept of the disclosure. Therefore, such adaptations and modifications are intended to be within the meaning and range of equivalents based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described example embodiments, but should be defined only in accordance with the following claims and their equivalents.

What is claimed is:

1. A computer-implemented method, comprising:
executing a plug-in on a computing device;
in response to the executing the plug-in, generating an emulator for testing a hybrid application, the emulator simulating an operating system of a client device such that, during testing, the hybrid application replicates operations of a browser operating on the client device;
installing the hybrid application in the emulator;
notifying a server that the hybrid application is ready for testing;
executing instructions received from the server for testing the hybrid application; and
providing results from testing the hybrid application to the server.

2. The method of claim 1, further comprising removing the emulator from the computing device after providing the results to the server.

3. The method of claim 1, wherein the instructions for testing the hybrid application include a web address for testing the hybrid application, and wherein the method further comprises directing the hybrid application to the web address.

4. The method of claim 1, wherein generating the emulator comprises identifying one or more system images provided in a software development kit (SDK) for the operating system of the client device, based on the SDK being installed on the computing device.

5. The method of claim 4, wherein generating the emulator further comprises receiving a selection of a system image from among the one or more system images, and wherein the emulator is generated based on the selected system image.

6. The method of claim 4, wherein generating the emulator is based on a default system image from among the one or more system images.

7. The method of claim 1, wherein the installing the hybrid application in the emulator comprises installing the hybrid application in response to the determining that the emulator is active on the computing device.

8. The method of claim 1, wherein the notifying the server comprises notifying the server in response to the hybrid application being launched in the emulator.

9. The method of claim 1, further comprising executing the plug-in in response to receiving instructions to execute the plug-in, wherein the instructions include a file location on the computing device for retrieving the hybrid application.

10. A device, comprising:
a memory; and
a processor coupled to the memory and configured to:
execute a plug-in on a the device;
in response to the executing the plug-in, generate an emulator for testing a hybrid application, the emulator simulating an operating system of a client device such that, during testing, the hybrid application replicates operations of a browser operating on the client device;
installing the hybrid application in the emulator;
notify a server that the hybrid application is ready for testing;
execute instructions received from the server for testing the hybrid application; and
provide results from testing the hybrid application to the server.

11. The device of claim 10, wherein the process is further configured to remove the emulator from the device after providing the results to the server.

12. The device of claim 10, wherein the instructions for testing the hybrid application include a web address for testing the hybrid application, and wherein the processor is further configured to direct the hybrid application to the web address.

13. The device of claim 10, wherein, to generate the emulator, the processor is further configured to identify one or more system images provided in a software development kit (SDK) for the operating system of the client device, based on the SDK being installed on the computing device.

14. The device of claim 13, wherein, to generate the emulator, the processor is further configured to receive a selection of a system image from among the one or more system images, and wherein the emulator is generated based on the selected system image.

15. The device of claim 13, wherein the emulator is generated based on a default system image from among the one or more system images.

16. A non-transitory computer-readable device having instructions stored thereon that, when executed by at least one computing device, cause the at least one computing device to perform operations comprising:
executing a plug-in on a computing device;
in response to the executing the plug-in, generating an emulator for testing a hybrid application, the emulator simulating an operating system of a client device such that, during testing, the hybrid application replicates operations of a browser operating on the client device;
installing the hybrid application in the emulator;
notifying a server that the hybrid application is ready for testing;
executing instructions received from the server for testing the hybrid application; and
providing results from testing the hybrid application to the server.

17. The non-transitory computer-readable device of claim 16, wherein the operations further comprise removing the emulator from the computing device after providing the results to the server.

18. The non-transitory computer-readable device of claim 16, wherein the instructions for testing the hybrid application include a web address for testing the hybrid application, and wherein the operations further comprise directing the hybrid application to the web address.

19. The non-transitory computer-readable device of claim 16, wherein the notifying the server comprises notifying the server in response to the hybrid application being launched in the emulator.

20. The non-transitory computer-readable device of claim 16, wherein the operations further comprise executing the plug-in in response to receiving instructions to execute the plug-in, wherein the instructions include a file location on the computing device for retrieving the hybrid application.
